(19) United States
(12) Patent Application Publication
(10) Pub. No.: US 2005/0044001 A1
(43) Pub. Date: Feb. 24, 2005

(54) Purchase price protection agent

(75) Inventor: Chandrasekhar Narayanaswami, Wilton, CT (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 10/643,730

(22) Filed: Aug. 18, 2003

(51) Int. Cl. G06F 17/60; G06F 17/00

(52) U.S. Cl. 705/26

(57) ABSTRACT

A system, method and computer readable medium for offering purchase price protection for a product and/or service is disclosed. The method, at a first web site, includes allowing a user to enter information associated with a product and/or service that was purchased by the user from a vendor, wherein the information includes the purchase price of the product and/or service and wherein the vendor offers purchase price protection for the product and/or service. The method further includes determining, at a second web site, a price for the product and/or service and determining whether the user is due a purchase price protection refund based on the price determined from the second web site. The method further includes sending a notice to the user informing him of the purchase price protection refund he is due.

### BACKGROUND OF THE INVENTION

1. Field of the Invention

This invention generally relates to the field of e-commerce web sites and more specifically to purchase price protection using an e-commerce web site.

2. Description of Related Art

As use of the World Wide Web increases, businesses and individuals are increasingly turning to this medium to conduct their business. The web has proven itself as a very efficient tool for conducting business and selling products and services. Traditional brick and mortar retailers have come to realize that the World Wide Web is another distribution channel that they can utilize to increase their sales both in-store and online, as well as improve their overall customer's satisfaction.

With the advent of this new medium as a retail distribution channel comes the inherent challenges associated with selling products via an electronic medium. Many products and/or services sold over the web are available in a variety of configurations. A computer, for example, can be configured in a variety of ways so as to provide varying sizes of hard disk space and memory. Typically, a consumer visits a web site and selects a particular configuration of a product, such as a computer. Subsequently, the web site calculates a price based on the selected configuration. This paradigm, however, makes it difficult to monitor the prices of competitors, as the selection of a configuration is necessary.

Price is still a major buying factor that is used to attract and retain web customers. As such, people running the web sites for electronic commerce, typically monitor competitor prices and adjust their own prices based on this and other price factors. This process is often a combination of manual and traditional methods used in regular commerce and looking at prices listed on the web by competitors. Third party web sites provide price comparison tools for simple and well-specified products, such as a particular model of a camcorder. However, the current process does not support the selection of options of a particular product and/or service so as to create a configuration of the product and/or service. Thus, in situations where a configurable product, such as a computer, is in issue, it is not possible to monitor competitor prices in an automated fashion. Other configurable products include furniture, cars, boats, etc.

Purchase price protection is another common feature that is used to entice customers into buying products and/or services. There are several different types of purchase price protection offered by retailers. One common form of purchase price protection includes insuring the purchase price of the product and/or service for a period of time, such as 30 or 60 days. Thus, if the customer sees the same configuration of the product and/or service at any other store (whether physical retail store or e-commerce web site) for a price less than the purchase price, then the retailer will refund the customer the difference.

Monitoring other stores for prices, however, can be time-consuming and tedious. The large number of retail stores on the web, compounded by the time necessary to extract product prices makes monitoring impractical. As such, many consumers allow their purchase price protection to lapse without ever using it. Further, many consumers do not give much value to purchase price protection plans, as they know that they are not going to monitor prices for 30 or 60 days. As a result, purchase price protection plans have lost some of their value to consumers.

Therefore a need exists to overcome the problems with the prior art as discussed above, and particularly for a way to more efficiently offer purchase price protection to consumers.

### SUMMARY OF THE INVENTION

Briefly, in accordance with the present invention, disclosed is a system, method and computer readable medium for offering purchase price protection for a product and/or service. In an embodiment of the present invention, the method on a first web site includes allowing a user to enter information associated with a product and/or service that was purchased by the user from a vendor, wherein the information includes the purchase price of the product and/or service and wherein the vendor offers purchase price protection for the product and/or service. The method further includes determining on a second web site a price for the product and/or service and determining whether the user is due a purchase price protection refund based on the price determined from the second web site. The method further includes sending an indication, such as a notice, to the user indicating that the purchase price protection refund is due.

In an embodiment of the present invention, the method further includes providing the user with information necessary for redeeming the refund he is due from the purchase price protection offered by the vendor, such that the user may redeem the refund directly from the vendor. In another embodiment of the present invention, the method further includes sending to the user a refund corresponding to the refund he is due from the purchase price protection offered by the vendor and redeeming from the vendor, on behalf of the user, the refund the user is due from the purchase price protection offered by the vendor.

In another embodiment of the present invention, disclosed is a computer program product comprising computer instructions on a first web site for offering purchase price protection for a product and/or service. The computer instructions including instructions for allowing a user to enter information associated with a product and/or service that was purchased by the user from a vendor, wherein the information includes the purchase price of the product and/or service and wherein the vendor offers purchase price protection for the product and/or service. The computer instructions further include instructions for determining on a second web site a price for the product and/or service and determining whether the user is due a purchase price protection refund based on the price determined from the second web site. The computer instructions further include instructions for sending an indication, such as a notice, to the user indicating that the purchase price protection refund is due.

In another embodiment of the present invention, disclosed is a system for offering purchase price protection for a product and/or service. The system includes a first web site for allowing a user to enter information associated with a product and/or service that was purchased by the user from a vendor, wherein the information includes the purchase price of the product and/or service and wherein the vendor offers purchase price protection for the product and/or service. The system further includes a spider for determining on a second web site a price for the product and/or service and a processor for determining whether the user is due a purchase price protection refund based on the price determined from the second web site. The system further includes a transmitter for sending an indication, such as a notice, to the user indicating that the purchase price protection refund is due.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the overall system architecture of one embodiment of the present invention.

FIG. 2 is a block diagram depicting the overall operation and control flow of the purchase price protection process, according to one embodiment of the present invention.

FIG. 3A is an illustration of a conventional product configuration web page.

FIG. 3B is an illustration of a web page for entering purchase price protection, according to one embodiment of the present invention.

FIG. 4 is a block diagram showing the system components used during the purchase price protection process, according to one embodiment of the present invention.

FIG. 5 is a flowchart depicting the operation and control flow of the overall process of one embodiment of the present invention.

FIG. 6 is a flowchart depicting the operation and control flow of the price collection process of one embodiment of the present invention.

FIG. 7 is a block diagram of a computer system useful for implementing an embodiment of the present invention.

### DETAILED DESCRIPTION OF THE PREFERRED EMBODIMENTS

The present invention, according to a preferred embodiment, overcomes problems with the prior art by providing an efficient and easy-to-implement system for providing competitive pricing of products to online shoppers. The exemplary embodiments of the present invention provide a system wherein a retail web site uses simulated orders at a competitor's web site to calculate competitive prices.

Overview

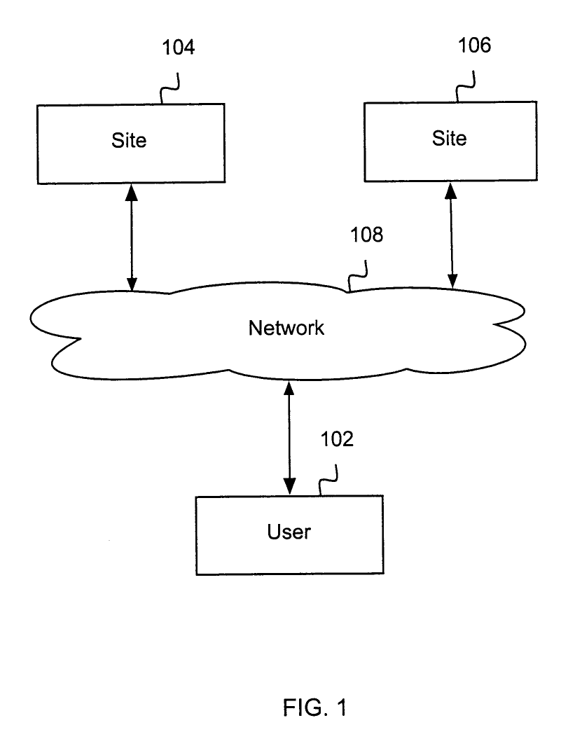

FIG. 1 is a block diagram illustrating the overall system architecture of one embodiment of the present invention. The exemplary embodiments of the present invention adhere to the system architecture of FIG. 1.

A web site 106, typically an e-commerce web site that sells products and/or services, is connected to a wide area network 108, such as the Internet. A user 102, operating on a client information processing system, or client computer, is also connected to the network 108. The user 102 utilizes a client application, such as a web browser, on his client computer to connect to the web site 106 via the network 108. Once connected to the web site 106, the user 102 browses through the products and/or services offered by web site 106 by navigating through the web pages on the site. The products and/or services offered by web site 106 are available in a plurality of configurations. Subsequently, the web site 106 will offer a selected configuration of a product and/or service for sale to the user 102 at a given price. The user 102 then has the option of purchasing the configuration of the product and/or service online, or while connected to the web site 106.

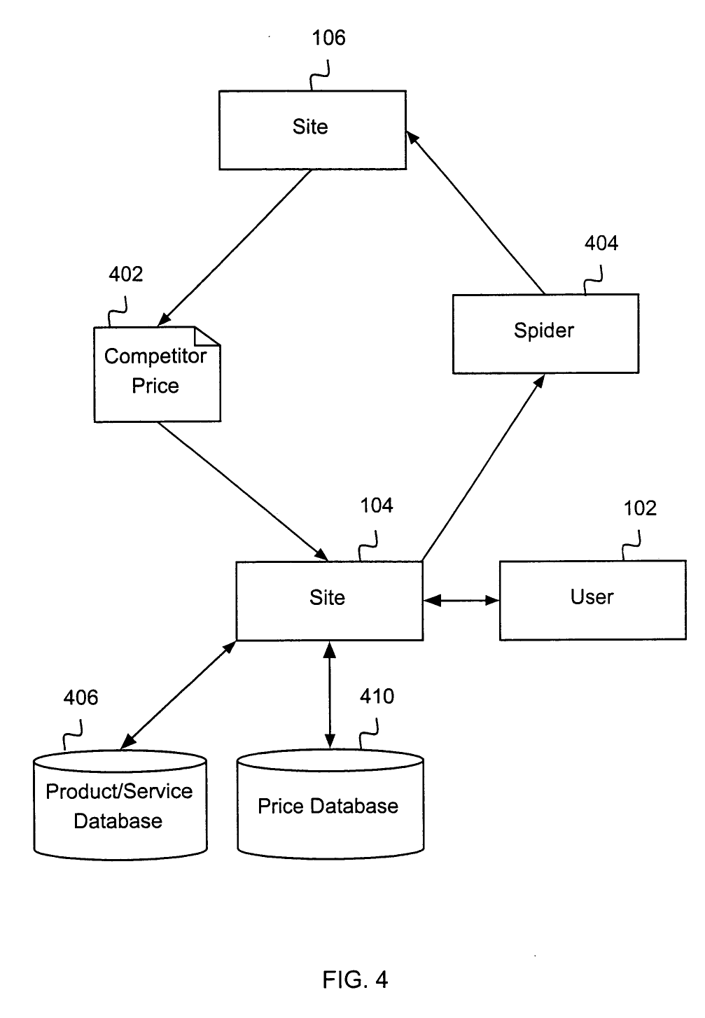

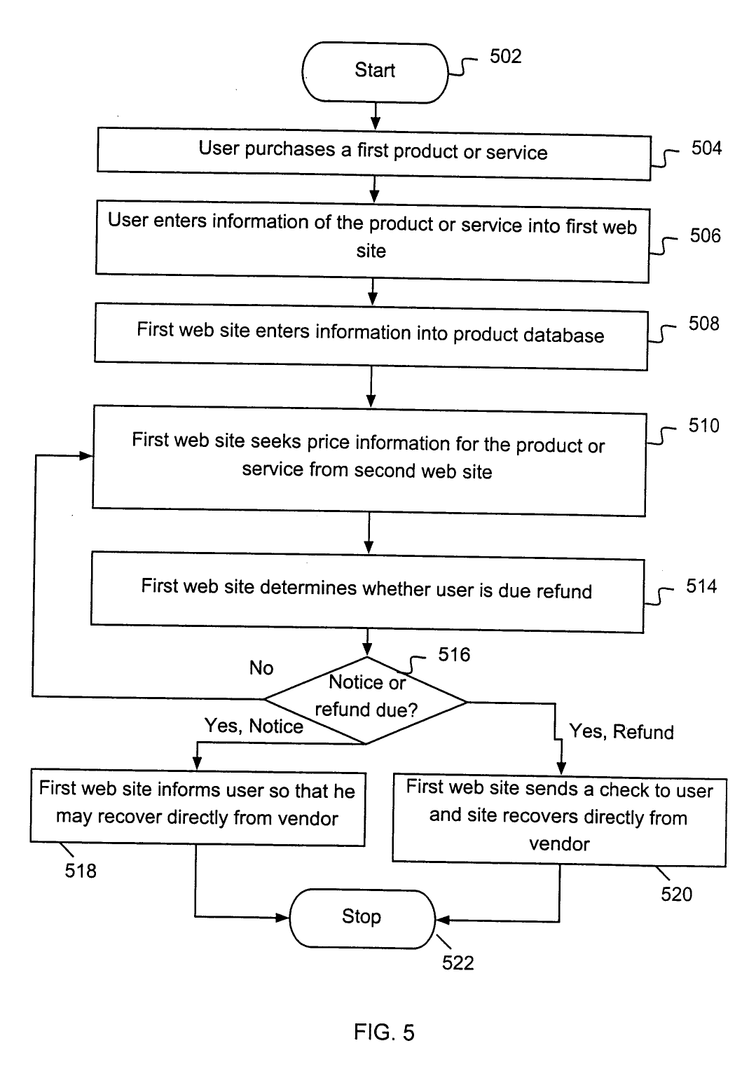

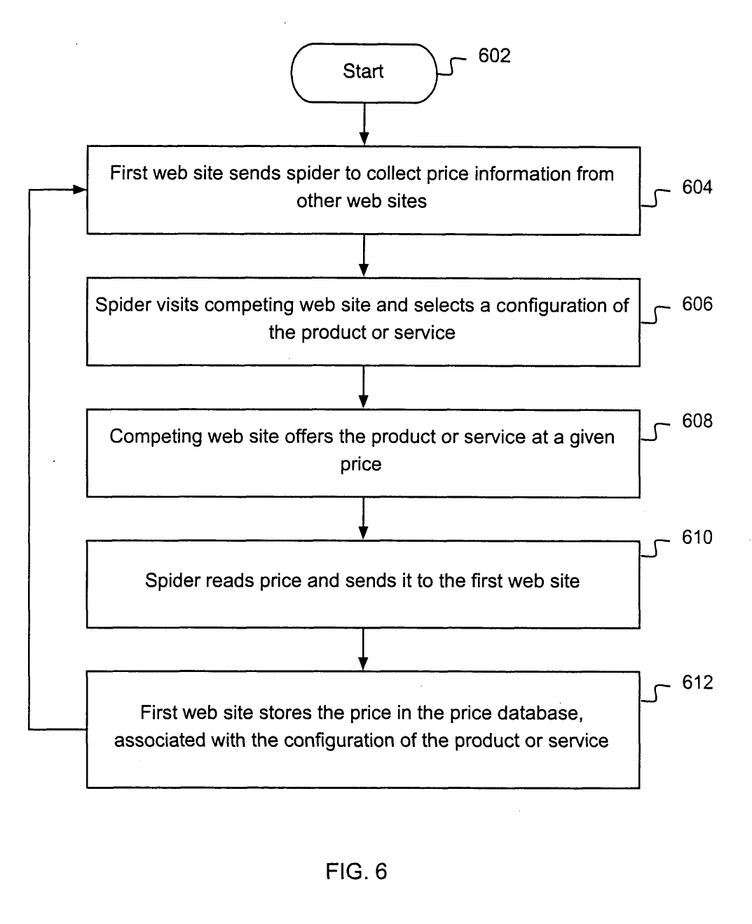

Web site 104 is web site that offers the services of a purchase price protection agent. In order to provide purchase price protection, the web site 104 collects pricing information from the retail web site 106—the place where the user 102 purchased a product and/or service with purchase price protection. This is described in greater detail with reference to FIG. 6 below. The web site 104 determines whether the user 102 is due a purchase price protection refund based on the price collected from the web site 106. This is also described in greater detail with reference to FIGS. 4-5 below. It should be noted that although FIG. 1 shows only one retail web site 106 and one user 102, the system of the present invention supports any number of retail web sites and any number of users.

In an embodiment of the present invention, certain actions performed by user 102, such as the selection of a configuration of a product and/or service on a web page of web site 106 or registration with the web site 104, are performed by a client application, such as a Java applet, a Java scriptlet, Java script, Perl script or an Active X control. In another embodiment of the present invention, certain actions performed by site 104, such as the purchase price protection determination process, are performed by a server application on the server 104 such as a Common Gateway Interface (CGI) script, a Java servlet, a Hypertext Preprocessor (PHP) script or a Perl script.

In another embodiment of the present invention, the computer systems of site 104, site 106 and user 102 are one or more Personal Computers (PCs) (e.g., IBM or compatible PC workstations running the Microsoft Windows 95/98/2000/ME/CE/NT/XP operating system, Macintosh computers running the Mac OS operating system, or equivalent), Personal Digital Assistants (PDAs), game consoles or any other information processing devices. In another embodiment of the present invention, the computer systems of site 104, site 106 and user 102 are server systems (e.g., SUN Ultra workstations running the SunOS operating system or IBM RS/6000 workstations and servers running the AIX operating system).

FIG. 1 also shows network 108 for connecting client 102 to web sites 104 and 106. In one exemplary embodiment of the present invention, network 108 is a circuit switched network, such as the Public Service Telephone Network (PSTN). In another exemplary embodiment of the present invention, the network 108 comprises a packet switched network. The packet switched network comprises a wide area network (WAN), such as the global Internet, a private WAN, a local area network (LAN), a telecommunications network or any combination of the above-mentioned networks. In another exemplary embodiment of the present invention, network 108 comprises a wired network, a wireless network, a broadcast network, or a point-to-point network.

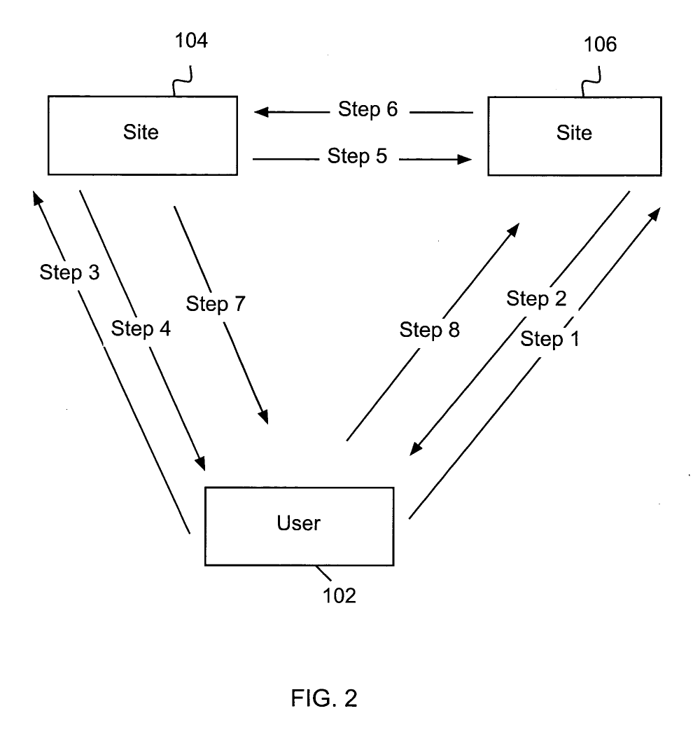

FIG. 2 is a block diagram depicting the overall operation and control flow of the purchase price protection process, according to one embodiment of the present invention. FIG. 2 shows eight steps describing in more detail the process of providing a purchase price protection agent for a product and/or service purchased at another web site.

As explained above, the web site 106 is an exemplary e-commerce web site that sells products and/or services over the Internet. In step 1, the user 102 utilizes a client application, such as a web browser, on his client computer to connect to the web site 106 via the network 108. Once connected to the web site 106, the user 102 browses through the products and/or services offered by web site 106 by navigating through the web pages on the site. The products and/or services offered by web site 106 are available in a plurality of configurations.

Subsequently, in step 2, the web site 106 will offer a selected configuration of a product and/or service for sale to the user 102 at a given price. The web site 106 will also offer some form of purchase price protection for the selected configuration of the product and/or service to the user 102. The user 102 then has the option of purchasing the configuration of the product and/or service online, or while connected to the web site 106. The user 102 purchases a configuration of the product and/or service from web site 106.

Next, in step 3, the user 102 visits the web site 104. Web site 104 is web site that offers the services of a purchase price protection agent. In step 4, the user 102 registers his purchase with the web site 104. The web site 104 allows the user 102 to enter information associated with the product and/or service that was purchased by the user 102 from web site 106, wherein the information includes the purchase price of the product and/or service. The information associated with a product and/or service that was purchased by the user 102 may also include the name of the product and/or service, a description of the product or service, an identifier of the product and/or service, the name, address and telephone number of the web site 106, the date the product and/or service was purchased by the user 102, the price the user 102 paid for the product and/or service, the type of purchase price protection offered by the web site 106, bank account information of the user 102 for direct deposit purposes and contact information of the user 102.

Once the user 102 has registered his purchase with the web site 104, the web site 104 can, in step 4, proceed to offer purchase price protection to the user 102. In order to provide purchase price protection, the web site 104, in step 5, collects pricing information from the retail web site 106—the place where the user 102 purchased a product and/or service with purchase price protection. Collecting pricing information from the retail web site 106 includes visiting the web site 106, selecting the configuration of the product and/or service on the web site 106 and reading from the web site 106, in step 6, a price associated with the configuration of the product and/or service.

Next, the web site 104 determines whether the user 102 is due a purchase price protection refund based on the price collected from the web site 106. This is accomplished by determining 1) a time period of the purchase price protection offered by the web site 106 for the product and/or service, 2) the current time, 3) the purchase price of the product and/or service and 4) the price of the product and/or service determined from the web site 106. If the current time is within the time period of the purchase price protection and the purchase price of the product and/or service is greater than the price determined from the web site 106, then the user 102 is due a purchase price protection refund. Otherwise, the user 102 is not due a purchase price protection refund.

In step 7, the web site 104 determines that the user 102 is due a purchase price protection refund and sends an indication, such as a notice, to the user 102 indicating (e.g., informing the user) of the purchase price protection refund that is due. In step 7, the web site 104 provides the user 102 with information necessary for redeeming the refund he is due from the purchase price protection offered by the web site 106, such that the user 102 may redeem the refund directly from the web site 106 in step 8.

In an alternative to step 8, the web site 104 may send to the user 102 the indication and a refund corresponding to the refund he is due from the purchase price protection offered by the web site 106. Then the web site 104 may redeem from the web site 106, on behalf of the user 102, the refund the user 102 is due from the purchase price protection offered by the web site 106.

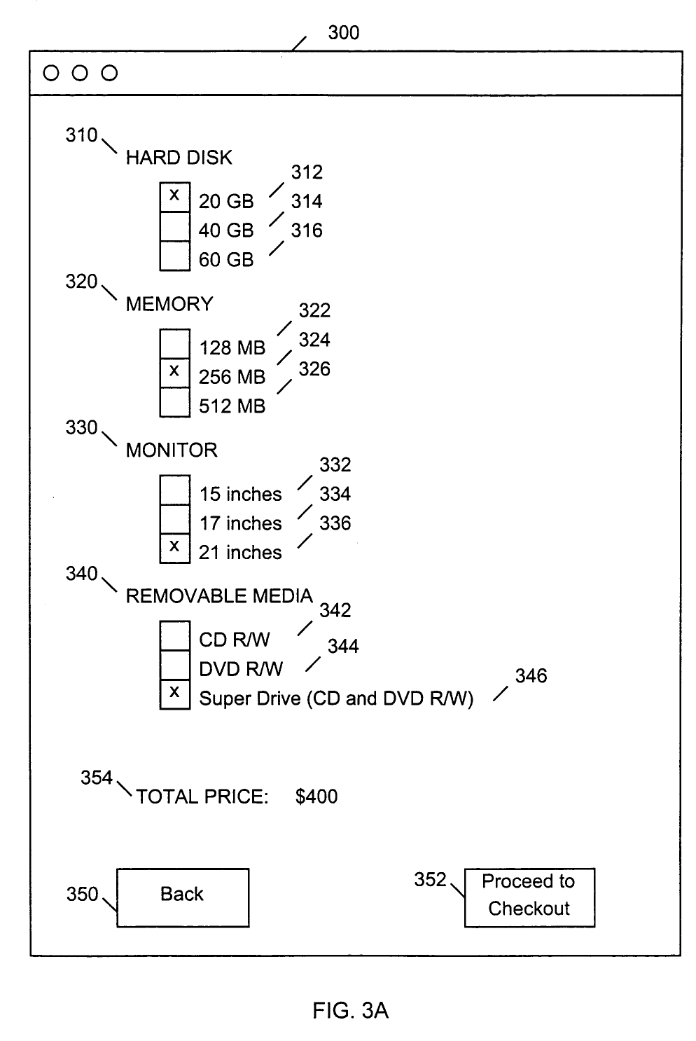

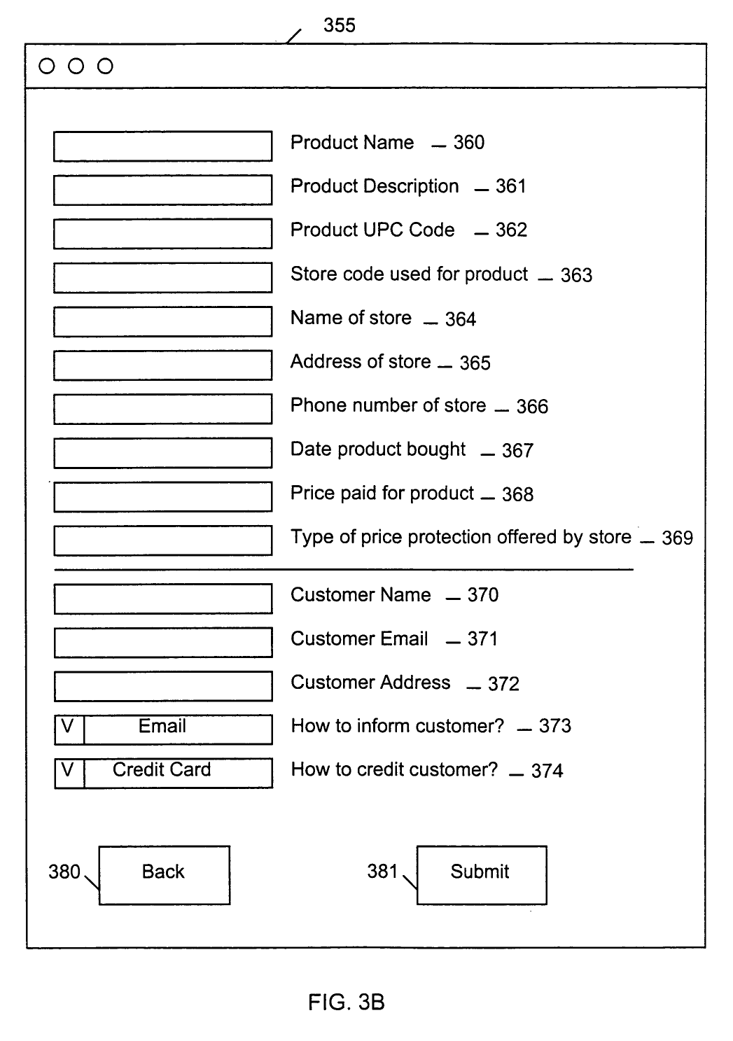

FIG. 3A is an illustration of a conventional product configuration web page 300. FIG. 3A shows a conventional web page 300 that is used to select a configuration of a product for sale on a web site such as web site 106. FIG. 3A shows an exemplary web page 300 that is used by a user 102 for selecting a configuration of a computer for sale on a web site, such as web site 106.

FIG. 3A shows a first configuration selection 310 for specifying the type of hard disk desired by the user 102 in the computer he intends to purchase. The first configuration selection 310 includes three options 312, 314 and 316, corresponding to 20 Gigabytes (GB), 40 GB and 60 GB, respectively. Next to each of the three options 312, 314 and 316 is a check box for selecting one option. FIG. 3A shows that the user 102 has selected option 312.

FIG. 3A also shows a second configuration selection 320 for specifying the type of memory desired by the user 102 in the computer he intends to purchase. The second configuration selection 320 includes three options 322, 324 and 326, corresponding to 128 Megabytes (MB), 256 MB and 512 MB, respectively. Next to each of the three options 322, 324 and 326 is a check box for selecting one option. FIG. 3A shows that the user 102 has selected option 324.

FIG. 3A also shows a third configuration selection 330 for specifying the type of monitor desired by the user 102 in the computer he intends to purchase. The third configuration selection 330 includes three options 332, 334 and 336, corresponding to 15 inches, 17 inches and 21 inches, respectively. Next to each of the three options 332, 334 and 336 is a check box for selecting one option. FIG. 3A shows that the user 102 has selected option 336.

FIG. 3A also shows a fourth configuration selection 340 for specifying the type of removable media desired by the user 102 in the computer he intends to purchase. The fourth configuration selection 340 includes three options 342, 344 and 346, corresponding to a Compact Disc Read/Write (CD R/W) drive, a Digital Versatile Disc (DVD) R/W drive and a Super Drive (CD R/W and DVD R/W), respectively. Next to each of the three options 342, 344 and 346 is a check box for selecting one option. FIG. 3A shows that the user 102 has selected option 346.

Further, FIG. 3A shows a total price line 354, which indicates the price at which the web site is offering for sale the particular configuration of the computer selected in the web page 300. FIG. 3A also shows a back button 350 for navigating a web page displayed previous to web page 300 and a “proceed to checkout” button 352 for continuing the process of purchasing the computer that was selected in the web page 300.

FIG. 3B is an illustration of a web page 355 for entering purchase price protection, according to one embodiment of the present invention. Exemplary FIG. 3B shows a web page 355 for entering purchase price protection for registering a configuration of a product and/or service that was purchased on a web site such as web site 106.

FIG. 3B shows a list of text fields and identifiers for specifying some of the type of information that is used by web site 104 in order to start the purchase price protection process. Text field 360 allows a user 102 to enter the name and configuration of the product and/or service purchased at the web site 106. Text field 361 allows a user 102 to enter a short description of the configuration of the product and/or service purchased at the web site 106. Text field 362 allows a user 102 to enter a Universal Product Code (UPC) or other common identifier for the configuration of the product and/or service purchased at the web site 106. Text field 363 allows a user 102 to enter a store-specific code or other identifier used to identify configuration of the product and/or service purchased at the web site 106.

Text field 364 allows a user 102 to enter the name of the web site 106 where the product and/or service was purchased. Text field 365 allows a user 102 to enter the address (street, email and/or URL) of the web site 106 where the product and/or service was purchased. Text field 366 allows a user 102 to enter the telephone number of the web site 106 where the product and/or service was purchased. Text field 367 allows a user 102 to enter the date when the product and/or service was purchased at the web site 106. Text field 368 allows a user 102 to enter the price that was paid for the product and/or service purchased at the web site 106.

Text field 369 allows a user 102 to enter the type of purchase price protection offered by the web site 106 for the product and/or service purchased at the web site 106. There are several different types of purchase price protection offered by retailers. One common form of purchase price protection includes insuring the purchase price of the configuration of the product and/or service for a period of time, such as 30 or 60 days. Thus, if the customer sees the same configuration of the product and/or service at any other store for a price less than the purchase price, then the web site 106 will refund the customer the difference.

Text field 370 allows a user 102 to enter his name. Text field 371 allows a user 102 to enter his email address. Text field 372 allows a user 102 to enter his home address. The pull down menu 373 allows a user 102 to indicate how he desires to be informed if the web site 104 determines that he is entitled to a refund. The user 102 may choose from a variety of options, including email and postal mail. The pull down menu 374 allows a user 102 to indicate how he desires to be refunded of the web site 104 determines that he is entitled to a refund and the web site 104 gives the refund to the user 102 directly. The user 102 may choose from a variety of options, including credit card, check or money order.

Back button 380 allows a user 102 to navigate to a previous web page. Submit button 381 allows a user 102 to submit his registration and commence the process of purchase price protection.

In one embodiment of the present invention, the web site 104 exacts a fee from the user 102 in exchange for offering the purchase price protection agent. In this embodiment, the web page 355 provides a means for the user 102 to enter a payment to the web site 104, such as via a credit card. In another embodiment of the present invention, the web site 104 exacts a commission from the user 102 in exchange for offering the purchase price protection agent. In this embodiment, if the web site 104 determines that the user 102 is due a refund from web site 106, the web site 104 pays a portion of the refund directly to the user 102. Then, the web site 104 collects the total refund directly from the web site 106, on behalf of the user 102.

FIG. 4 is a block diagram showing the system components used during the purchase price protection process, according to one embodiment of the present invention. FIG. 4 shows describes in more detail the components used during the process of providing a purchase price protection agent for a product and/or service purchased at another web site.

The web site 104 comprises routines or programs known as spiders 404. A spider 404 is a program that automatically fetches web pages and/or extracts or retrieves information. Spiders can be used to feed web pages to search engines. Another term for a spider is a webcrawler. The spider 404 of the web site 104 visits the web site 106 and collects pricing information 402 from the web site 106. This is described in greater detail with reference to FIG. 6 below.

As explained above, the price information 402 is utilized by the web site 104 in determining whether the user 102 is entitled a refund from the web site 106, due to the purchase price protection offered by the web site 106. Subsequently, the web site 104 collects the price information 402 and stores it in price database 410. The price database 410 is any commercially available database, such as the DB2 Universal Database available from International Business Machines of Armonk, N.Y.

The product and/or service database 406 is used to store information pertaining to the purchases that are registered by users 102, such as described with reference to FIG. 3B above. Examples of information that is stored in product and/or service database 406 include:
the name of the configuration of a product and/or service
a short description of a configuration of a product and/or service
a UPC or other universal identifier for a configuration of a product and/or service
a store code used to identify a configuration of a product and/or service
the name of the web site or store where the configuration of a product and/or service was purchased
the address (email, street, or URL) of the web site or store where the configuration of a product and/or service was purchased
the telephone number of the web site or store where the configuration of a product and/or service was purchased
the date the configuration of a product and/or service was purchased
the price paid for the configuration of a product and/or service
the type of purchase price protection offered for the configuration of a product and/or service
the name of the customer, i.e., user 102
the email address of the customer
the home address of the customer
a preference for informing the customer that he is due a refund
a preference for how the customer prefers to be refunded
   Like the price database 410, the product and/or service database 406 is any commercially available database. In one embodiment of the present invention, the price database 410 and the product and/or service database 406 are integrated into one database.

FIG. 5 is a flowchart depicting the operation and control flow of the overall process of one embodiment of the present invention. FIG. 5 describes in more detail the process of providing a purchase price protection agent for a product and/or service purchased at another web site. The control flow of FIG. 5 begins with step 502 and flows directly to step 504.

In step 504, the user 102 utilizes a client application, such as a web browser, on his client computer to connect to the web site 106 via the network 108. The products and/or services offered by web site 106 are available in a plurality of configurations. The web site 106 will also offer some form of purchase price protection for selected configurations of product and/or services to the user 102. The user 102 purchases a configuration of a product and/or service from web site 106.

In step 506, the user 102 visits the web site 104. Web site 104 is web site that offers the services of a purchase price protection agent. The user 102 registers his purchase with the web site 104. The web site 104 allows the user 102 to enter information associated with the product and/or service that was purchased by the user 102 from web site 106, wherein the information includes the purchase price of the product and/or service. The information associated with a product and/or service that was purchased by the user 102 may also include the name of the product and/or service, a description of the product or service, an identifier of the product and/or service, the name, address and telephone number of the web site 106, the date the product and/or service was purchased by the user 102, the price the user 102 paid for the product and/or service and the type of purchase price protection offered by the web site 106.

Once the user 102 has entered the appropriate information into a web page of the web site 104, such as web page 355, the web site 104 enters the information into the product database 406. Subsequently, the web site 104 can proceed to offer purchase price protection to the user 102.

In step 510 the web site 104, seeks pricing information for the product and/or service at the retail web site 106—the place where the user 102 purchased a product and/or service with purchase price protection—and stores it in price database 410. Collecting pricing information from the retail web site 106 includes visiting the web site 106, selecting the configuration of the product and/or service on the web site 106 and reading from the web site 106 a price associated with the configuration of the product and/or service.

Next, in step 514, the web site 104 determines whether the user 102 is due a purchase price protection refund based on the price collected from the web site 106. This is accomplished by determining 1) a time period of the purchase price protection offered by the web site 106 for the product and/or service, 2) the current time, 3) the purchase price of the product and/or service and 4) the price of the product and/or service determined from the web site 106. If the current time is within the time period of the purchase price protection and the purchase price of the product and/or service is greater than the price determined from the web site 106, then the user 102 is due a purchase price protection refund. Otherwise, the user 102 is not due a purchase price protection refund.

In step 516, the web site 104 determines whether the user 102 is due a purchase price protection refund. If the result of this determination is negative, then control flows back to step 510 where the web site 104 continues to seek prices at the web site 106. If the result of this determination is positive, then control flows to one of the alternative steps: step 518 or step 520.

In step 518, the web site 104 sends a notice to the user 102 informing him of the purchase price protection refund he is due. In this step, the web site 104 provides the user 102 with information necessary for redeeming the refund he is due from the purchase price protection offered by the web site 106, such that the user 102 may redeem the refund directly from the web site 106.

In an alternative step 520, the web site 104 sends to the user 102 a refund corresponding to (e.g., equal to—or minus a commission) the refund he is due from the purchase price protection offered by the web site 106. Then the web site 104 may redeem from the web site 106, on behalf of the user 102, the refund the user 102 is due from the purchase price protection offered by the web site 106. In step 522, the control flow of FIG. 5 stops.

FIG. 6 is a flowchart depicting the operation and control flow of the price collection process of one embodiment of the present invention. FIG. 6 describes in more detail the process of determining prices on web site 106. The control flow of FIG. 6 begins with step 602 and flows directly to step 604.

In step 604, the web site 104 sends a spider 404 to collect price information 402 from the web site 106. In step 606, the spider 404 visits the web site 106 and selects one configuration of a product and/or service, as shown by example in FIG. 3. In step 608, the web site 106 offers the selected configuration of the product and/or service at a given price 402. In step 610, the spider 404 reads the price information 402 and sends it to the web site 104. In step 612, the web site 104 receives the price information 402 and stores it in the price database 410, so as to correspond with the selected configuration of the product and/or service of the web site 104. Subsequently, the control flows back to step 604.

Exemplary Implementations

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

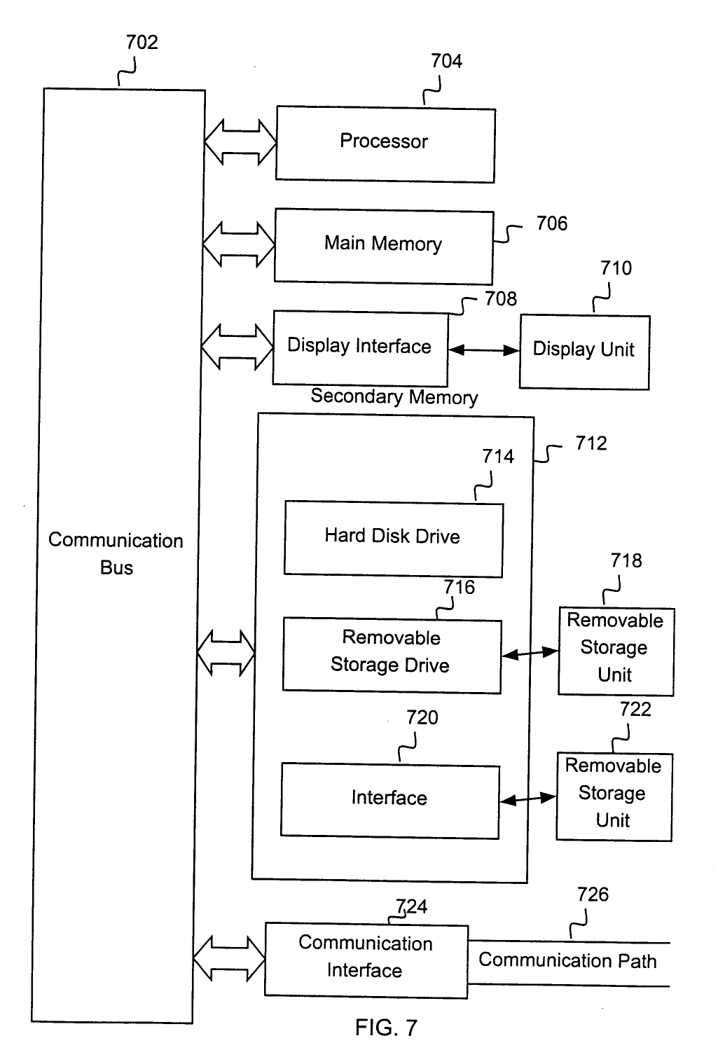

FIG. 7 is a block diagram of a computer system useful for implementing an embodiment of the present invention. The computer system includes one or more processors, such as processor 704. The processor 704 is connected to a communication infrastructure 702 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 702 (or from a frame buffer not shown) for display on the display unit 710. The computer system also includes a main memory 706, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents a floppy disk, magnetic tape, optical disk, etc. which is read by and written to by removable storage drive 716. As will be appreciated, the removable storage unit 718 includes a computer usable storage medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724.

Communications interface 724 allows software and data to be transferred between the computer system and external devices. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 706 and secondary memory 712, removable storage drive 716, a hard disk installed in hard disk drive 714, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method for offering purchase price protection for a product and/or service, the method comprising the steps of:
receiving, at a first web site, information from a user, the information being associated with a product and/or service that was purchased by the user from a vendor, wherein the information includes the purchase price of the product and/or service and wherein the vendor offers purchase price protection for the product and/or service;
determining, at a second web site, a price for the product and/or service;
determining whether the user is due a purchase price protection refund based on the price determined at the second web site; and
sending an indication to the user indicating that the purchase price protection refund is due.

2. The method of claim 1, wherein the information associated with a product and/or service that was purchased by the user from the vendor includes at least one of:
the name of the product and/or service;
a description of the product or service;
an identifier of the product and/or service;
the name, address and telephone number of the vendor;
the date the product and/or service was purchased by the user;
the price the user paid for the product and/or service; and
the type of purchase price protection offered by the vendor.

3. The method of claim 1, wherein the first determining step comprises the steps of:
visiting the second web site;
selecting the product and/or service on the second web site; and
reading from the second web site a price associated with the product and/or service.

4. The method of claim 1, wherein the second determining step comprises the steps of:
determining a time period of the purchase price protection offered by the vendor for the product and/or service, the current time, the purchase price of the product and/or service and the price of the product and/or service determined from the second web site; and
if the current time is within the time period of the purchase price protection and the purchase price of the product and/or service is greater than the price determined from the second web site, then determining that the user is due a purchase price protection refund; and
otherwise, determining that the user is not due a purchase price protection refund.

5. The method of claim 1, further comprising the step of:
providing the user with information necessary for redeeming the refund that is due from the purchase price protection offered by the vendor, such that the user may redeem the refund directly from the vendor.

6. The method of claim 1, further comprising the steps of:
sending to the user a refund corresponding to the refund due from the purchase price protection offered by the vendor; and
redeeming from the vendor, on behalf of the user, the refund the user is due from the purchase price protection offered by the vendor.

7. The method of claim 1, wherein each of the first web site and the second web site comprises an e-commerce web site.

8. A computer program product comprising computer instructions for operating on at least one web site for offering purchase price protection for a product and/or service, the computer instructions including instructions for:
receiving, at a first web site, information from a user, the information being associated with a product and/or service that was purchased by the user from a vendor, wherein the information includes the purchase price of the product and/or service and wherein the vendor offers purchase price protection for the product and/or service;
determining, at a second web site, a price for the product and/or service;
determining whether the user is due a purchase price protection refund based on the price determined at the second web site; and
sending an indication to the user indicating that the purchase price protection refund is due.

9. The computer program product of claim 8, wherein the information associated with a product and/or service that was purchased by the user from the vendor includes at least one of:
the name of the product and/or service;
a description of the product or service;
an identifier of the product and/or service;
the name, address and telephone number of the vendor;
the date the product and/or service was purchased by the user;
the price the user paid for the product and/or service; and
the type of purchase price protection offered by the vendor.

10. The computer program product of claim 8, wherein the instructions for the first determining step comprise instructions for:
visiting the second web site;
selecting the product and/or service on the second web site; and
reading from the second web site a price associated with the product and/or service.

11. The computer program product of claim 8, wherein the instructions for the second determining step comprise instructions for:
determining a time period of the purchase price protection offered by the vendor for the product and/or service, the current time, the purchase price of the product and/or service and the price of the product and/or service determined from the second web site; and
if the current time is within the time period of the purchase price protection and the purchase price of the product and/or service is greater than the price determined from the second web site, then determining that the user is due a purchase price protection refund; and
otherwise, determining that the user is not due a purchase price protection refund.

12. The computer program product of claim 8, further comprising instructions for:
providing the user with information necessary for redeeming the refund that is due from the purchase price protection offered by the vendor, such that the user may redeem the refund directly from the vendor.

13. The computer program product of claim 8, further comprising instructions for:
sending to the user a refund corresponding to the refund due from the purchase price protection offered by the vendor; and
redeeming from the vendor, on behalf of the user, the refund the user is due from the purchase price protection offered by the vendor.

14. The computer program product of claim 8, wherein each of the first web site and the second web site comprises an e-commerce web site.

15. A system for offering purchase price protection for a product and/or service, comprising:
a first web site for receiving information from a user, the information being associated with a product and/or service that was purchased by the user from a vendor, wherein the information includes the purchase price of the product and/or service and wherein the vendor offers purchase price protection for the product and/or service;
a spider for determining on a second web site a price for the product and/or service;
a processor for determining whether the user is due a purchase price protection refund based on the price determined from the second web site; and
a transmitter for sending an indication to the user indicating that the purchase price protection refund is due.

16. The system of claim 15, wherein the information associated with a product and/or service that was purchased by the user from the vendor includes at least one of:
the name of the product and/or service;
a description of the product or service;
an identifier of the product and/or service;
the name, address and telephone number of the vendor;
the date the product and/or service was purchased by the user;
the price the user paid for the product and/or service; and
the type of purchase price protection offered by the vendor.

17. The system of claim 15, wherein the spider for visiting the second web site, selecting the product and/or service on the second web site, and reading from the second web site a price associated with the product and/or service.

18. The system of claim 15, wherein the processor further comprises:
means for determining a time period of the purchase price protection offered by the vendor for the product and/or service, the current time, the purchase price of the product and/or service and the price of the product and/or service determined from the second web site; and
if the current time is within the time period of the purchase price protection and the purchase price of the product and/or service is greater than the price determined from the second web site, then determining that the user is due a purchase price protection refund; and
otherwise, determining that the user is not due a purchase price protection refund.

19. The system of claim 15, wherein the transmitter further for providing the user with information necessary for redeeming the refund due from the purchase price protection offered by the vendor, such that the user may redeem the refund from the vendor.

20. The system of claim 15, wherein the transmitter further for sending to the user a refund corresponding to the refund due from the purchase price protection offered by the vendor.
